(19) United States
(12) Patent Application Publication
(10) Pub. No.: US 2008/0298871 A1
(43) Pub. Date: Dec. 4, 2008

(54) Pinwheel and printing apparatus having the same

(75) Inventor: Toru Iwabuchi, Tokyo (JP)

Correspondence Address: KUBOTERA & ASSOCIATES, LLC, SUITE 202, 200 DAINGERFIELD ROAD, ALEXANDRIA, VA, 22314, US

(73) Assignee: OKI DATA CORPORATION

(21) Appl. No.: 12/155,013

(22) Filed: May 29, 2008

(30) Foreign Application Priority Data
May 29, 2007 (JP) 2007-141823

(51) Int. Cl. B41J 11/28; B65H 20/20

(52) U.S. Cl. 400/616.3; 226/76

(57) ABSTRACT

A pinwheel includes a plurality of pins arranged on a circumferential surface thereof with a specific interval for engaging transportation holes of a medium, so that the medium is transported. Each of the pins has a lateral section having a substantially oval shape.

### BACKGROUND OF THE INVENTION

The present invention relates to a pinwheel and a printing apparatus having the pinwheel. The pinwheel engages with a transportation hole of a printing medium for transporting the printing medium.

A pinwheel 1 provided in a conventional printing apparatus such as an impact printer and the likes will be explained with reference to FIGS. 12(a) and 12(b). FIGS. 12(a) and 12(b) are schematic views showing the pinwheel 1 of the conventional printing apparatus. More specifically, FIG. 12(a) is a schematic plan view of the pinwheel 1, and FIG. 12(b) is a schematic side view of the pinwheel 1 (refer to Patent Reference).

### Patent Reference: Japan Patent Publication No. 08-324848

As shown in FIG. 12(b), the pinwheel 1 has a plurality of pins 2 perpendicularly protruding from a circumference thereof, and is capable of rotating in an arrow direction B. As shown in FIG. 12(a), each of the pins 2 has a circular lateral sectional shape with a diameter D in each of an arrow direction A, a direction perpendicular to the arrow direction A, and an opposite direction. Further, as shown in FIG. 12(b), each of the pins 2 has a cone vertical sectional shape with a pointed distal end.

FIG. 13 is a schematic enlarged view showing the pin 2 and a continuous medium 5 (referred to simply as a medium 5) having a transportation hole 5a in the conventional printing apparatus. As shown in FIG. 13, the pin 2 has a circular column shape with a diameter D slightly smaller than a diameter F of the transportation hole 5a. Accordingly, when the pinwheel 1 rotates and moves in the arrow direction A, the pin 2 contacts with the transportation hole 5a of the medium 5 at one position, i.e., a hidden line portion G.

FIG. 14 is a schematic view No. 1 showing the pin 2 of the pinwheel 1 of the conventional printing apparatus in an operational state. FIG. 15 is a schematic view No. 2 showing the pin 2 of the pinwheel 1 of the conventional printing apparatus in the operational state.

As shown in FIG. 14, base portions H of the pin 2 are formed of a straight surface. Accordingly, when the pin 2 is situated in a straight posture, the pin 2 is situated substantially in parallel to an edge of the transportation hole 5a of the medium 5.

As shown in FIG. 15, when the pinwheel 1 rotates and moves in the arrow direction A, the base portion H of the pin 2 is inclined with respect to the edge of the transportation hole 5a of the medium 5 from the parallel position. Accordingly, the pin 2 contacts with the transportation hole 5a of the medium 5 at a position shown as a hidden line portion I from the hidden line portion G. When the pinwheel 1 rotates further, the pin 2 comes off from the transportation hole 5a of the medium 5.

In the conventional printing apparatus with the pinwheel 1 described above, when the pin 2 contacts with the transportation hole 5a of the medium 5 at the hidden line portion I from the hidden line portion G, a stress may be locally concentrated on one point of the transportation hole 5a of the medium 5, thereby causing deformation in the transportation hole 5a of the medium 5 during the transportation. Further, the transportation hole 5a of the medium 5 slides against the base portions H of the pin 2 while a stress is applied to the pin 2, thereby causing noise through friction and the likes.

Further, when the pinwheel 1 rotates and moves in the arrow direction A, a side surface of the pin 2 abuts against the transportation hole 5a of the medium 5 while the pin 2 is being inclined, thereby further causing deformation and noise. Accordingly, it is difficult to print an image with high accuracy in a vertical direction. Further, noise may cause discomfort to a user of the conventional printing apparatus.

In view of the problem described above, an object of the invention is to provide a pinwheel and a printing apparatus, in which it is possible to solve the problems of the conventional printing apparatus.

Further objects of the invention will be apparent from the following description of the invention.

### SUMMARY OF THE INVENTION

In order to attain the objects described above, according to the present invention, a pinwheel includes a plurality of pins arranged on a circumferential surface thereof with a specific interval for engaging transportation holes of a medium, so that the medium is transported. Each of the pins has a lateral section having a substantially oval shape.

In a printing apparatus having the pinwheel described above, the pinwheel includes a plurality of pins arranged on the circumferential surface thereof with the specific interval for engaging the transportation holes of the medium, so that the medium is transported. Each of the pins has the lateral section having the substantially oval shape. Accordingly, the pin contacts with the transportation hole of the medium at a plurality of positions. Accordingly, it is possible to disperse a force pulling the transportation hole of the medium, thereby reducing deformation of the transportation hole of the medium and noise.

### BRIEF DESCRIPTION OF THE DRAWINGS

FIG. 1 is a schematic view showing a pin of a pinwheel and a transportation hole of a medium according to a first embodiment of the present invention;

FIG. 2 is a schematic view showing the pinwheel and a printing apparatus according to the first embodiment of the present invention;

FIG. 3 is a schematic view showing the pinwheel, the medium and a pinwheel guide according to the first embodiment of the present invention;

FIGS. 4(a) and 4(b) are schematic views showing the pinwheel according to the first embodiment of the present invention, wherein FIG. 4(a) is a schematic plan view of the pinwheel, and FIG. 4(b) is a schematic side view of the pinwheel;

FIG. 5 is a schematic view showing a pin of a pinwheel and a transportation hole of a medium according to a modified example of the first embodiment of the present invention;

FIG. 6 is a schematic view No. 1 showing the pinwheel and the medium in an operational state according to the first embodiment of the present invention;

FIG. 7 is a schematic view No. 2 showing the pinwheel and the medium in the operational state according to the first embodiment of the present invention;

FIG. 8 is a schematic view No. 3 showing the pinwheel and the medium in the operational state according to the first embodiment of the present invention;

FIG. 9 is a schematic side view showing a pinwheel according to a second embodiment of the present invention;

FIG. 10 is a schematic view showing a pin of the pinwheel according to the second embodiment of the present invention;

FIG. 11 is a schematic view showing the pinwheel and a medium in an operational state according to the second embodiment of the present invention;

FIGS. 12(a) and 12(b) are schematic views showing a pinwheel of a conventional printing apparatus, wherein FIG. 12(a) is a schematic plan view of the pinwheel, and FIG. 12(b) is a schematic side view of the pinwheel;

FIG. 13 is a schematic enlarged view showing a pin of the pinwheel and a medium having a transportation hole in the conventional printing apparatus;

FIG. 14 is a schematic view No. 1 showing the medium and the pinwheel of the conventional printing apparatus in an operational state; and

FIG. 15 is a schematic view No. 2 showing the medium and the pinwheel of the conventional printing apparatus in the operational state.

### DETAILED DESCRIPTION OF THE PREFERRED EMBODIMENTS

Hereunder, embodiments of the present invention will be described in detail with reference to the accompanying drawings. Similar components in the drawings are designated with the same numeral references. In the following description, a printing medium is a continuous sheet, and may be any sheet with a transportation hole to obtain a similar effect.

### First Embodiment

A first embodiment of the present invention will be explained. FIG. 2 is a schematic view showing a pinwheel 1 and a printing apparatus 10 according to the first embodiment of the present invention. As shown in FIG. 2, the printing apparatus 10 includes the pinwheel 1 with a circular shape, and the pinwheel 1 rotates in an arrow direction B through a drive force (not shown).

In the embodiment, the pinwheel 1 is provided with a plurality of pins 3 with a substantially oval shape arranged on a circumferential surface thereof with a specific interval in a perpendicular direction. A pinwheel guide 4 is provided for holding the pinwheel 1, so that a medium 5 set in the pinwheel 1 does not come off. Further, on a downstream side in a transportation direction, there are provided a platen 6 facing a print head 8 printing on the medium 5, and a paper pan 7 for guiding the medium 5 to the platen 6.

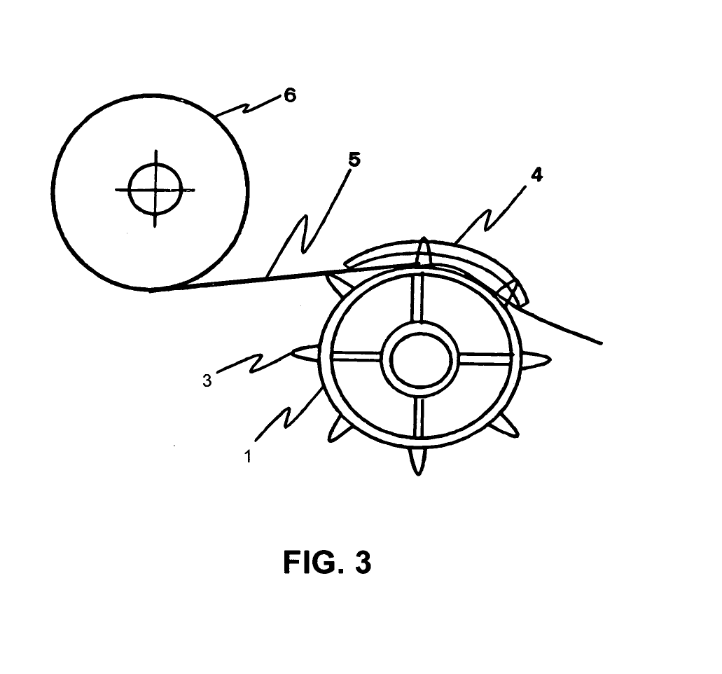

FIG. 3 is a schematic view showing the pinwheel 1, the medium 5, and the pinwheel guide 4 according to the first embodiment of the present invention. As shown in FIG. 3, the medium 5 is transported along a tangential line connected between the circumferential surface of the pinwheel 1 and a circumferential surface of the platen 6. Further, it is arranged such that the pinwheel guide 4 contacts with the medium 5.

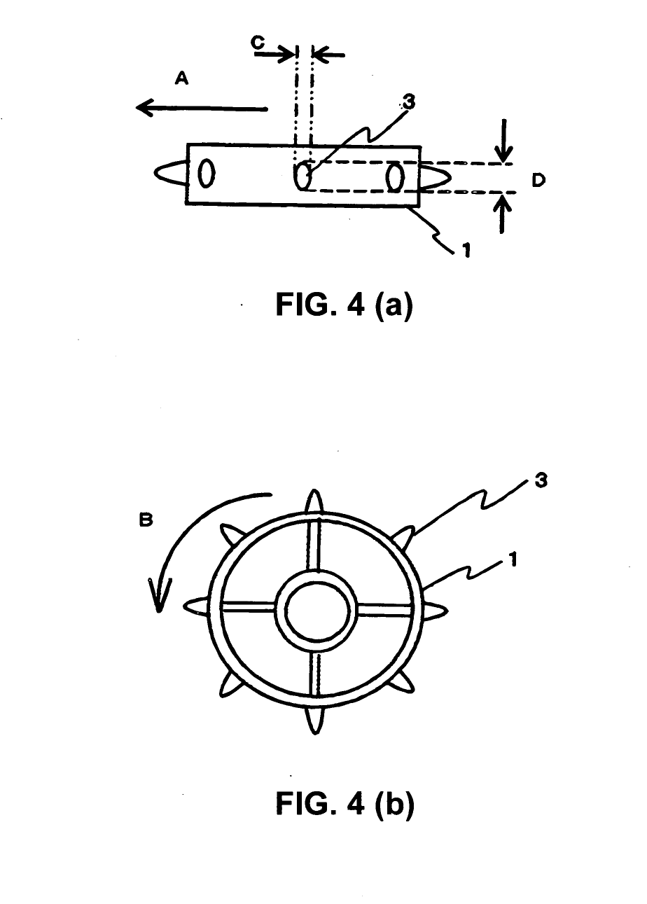

FIGS. 4(a) and 4(b) are schematic views showing the pinwheel 1 according to the first embodiment of the present invention. More specifically, FIG. 4(a) is a schematic plan view of the pinwheel 1, and FIG. 4(b) is a schematic side view of the pinwheel 1.

As shown in FIG. 4(b), a plurality of the pins 3 with the substantially oval shape protrudes perpendicularly relative to the circumferential surface of the pinwheel 1. As shown in FIG. 4(a), each of the pins 3 has a substantially oval lateral sectional shape with a diameter C in an arrow direction A, i.e., the transportation direction, smaller than a diameter D in a perpendicular direction. Further, as shown in FIG. 4(b), each of the pins 3 has a cone vertical sectional shape with a pointed distal end.

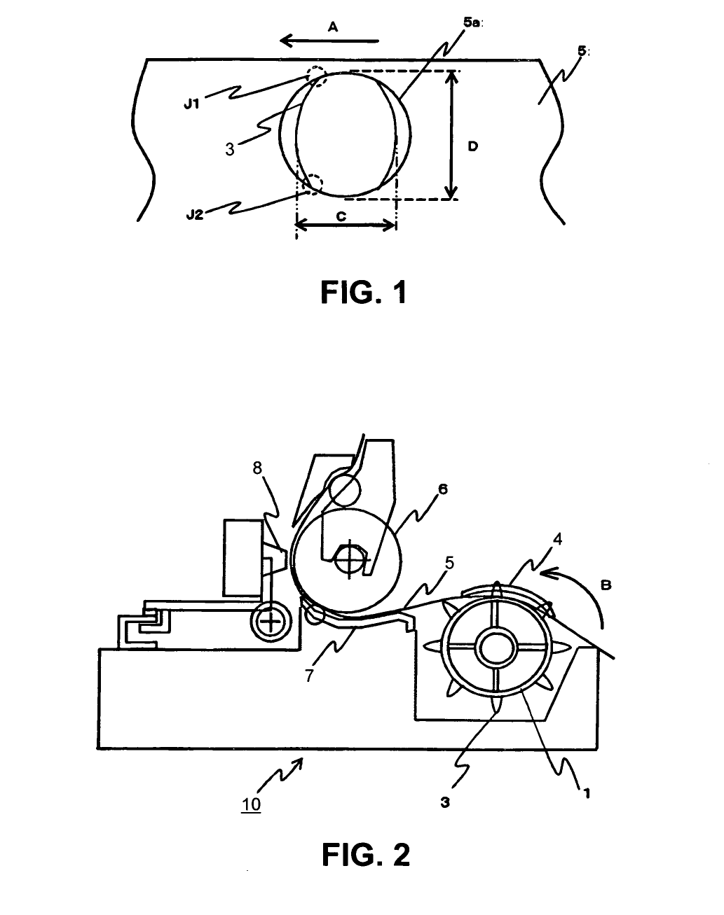

FIG. 1 is a schematic view showing the pin 3 of the pinwheel 1 and a transportation hole 5a of the medium 5 according to the first embodiment of the present invention. As shown in FIG. 1, the medium 5 is provided with the transportation hole 5a for engaging the pin 3 with the substantially oval shape.

In the embodiment, the pin 3 with the substantially oval shape has a radius curvature in an arrow direction A, indicated with the diameter C, larger than a radius curvature of the transportation hole 5a of the medium 5, indicated with the diameter D. Further, the pin 3 with the substantially oval shape has a substantially oval sectional shape. When the medium 5 is transported in the arrow direction A, the pin 3 with the substantially oval shape contacts with the transportation hole 5a at abutting positions J1 and J2.

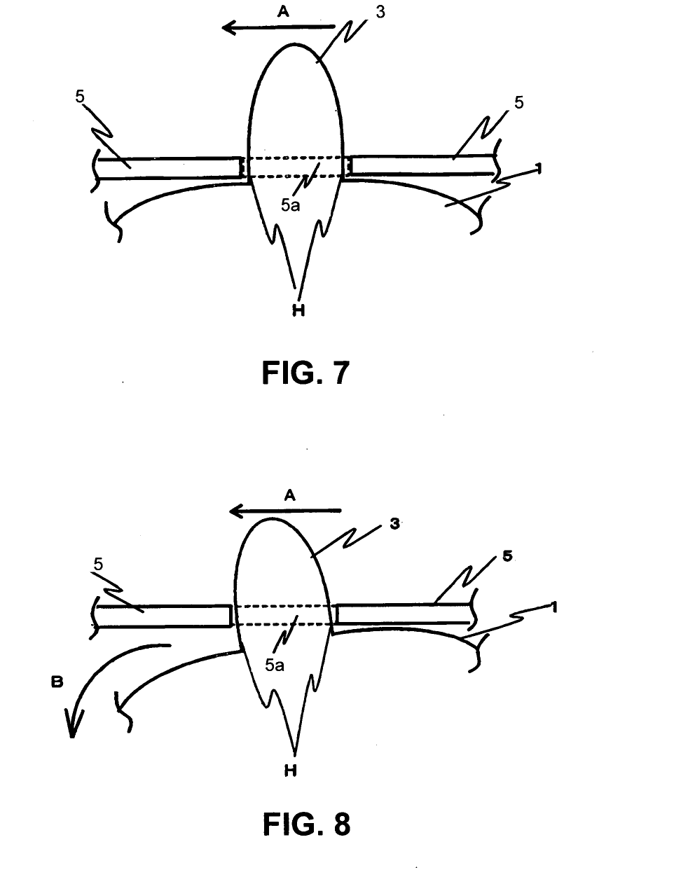

An operation of the printing apparatus 10 with the pinwheel 1 will be explained next with reference to FIGS. 6 to 8. FIG. 6 is a schematic view No. 1 showing the pinwheel 1 and the medium 5 in an operational state according to the first embodiment of the present invention. FIG. 7 is a schematic view No. 2 showing the pinwheel 1 and the medium 5 in the operational state according to the first embodiment of the present invention. FIG. 8 is a schematic view No. 3 showing the pinwheel 1 and the medium 5 in the operational state according to the first embodiment of the present invention.

In the operation, first, the pinwheel guide 4 is removed, and the transportation hole 5a of the medium 5 is set to the pin 3 with the substantially oval shape of the pinwheel 1. Then, the medium 5 is set with the pinwheel guide 4. When a printing operation is started or a transportation of a sheet is performed, the medium 5 is pressed with the pinwheel guide 4, and is transported in the arrow direction A along the circumferential surface of the pinwheel 1 while the pin 3 with the substantially oval shape engages the transportation hole 5a as shown in FIG. 6. At this time, the transportation hole 5a of the medium 5 abuts against a straight portion H of the pin 3 with the substantially oval shape at a base portion thereof.

As described above, as shown in FIG. 3, it is arranged such that the medium 5 is situated on the tangential line connected between the circumferential surface of the pinwheel 1 and the circumferential surface of the platen 6. Accordingly, when the pinwheel 1 rotates further, the medium 5 moves from a state shown in FIG. 7, in which the medium 5 is situated perpendicularly relative to the pin 3 with the substantially oval shape, to a state shown in FIG. 8, in which the pinwheel 1 rotates in the arrow direction B and the pin 3 with the substantially oval shape is inclined.

As described above, the pin 3 with the substantially oval shape has the substantially oval lateral sectional shape with the diameter C in the arrow direction A smaller than the diameter D in the direction perpendicular to the arrow direction A. Accordingly, the pin 3 with the substantially oval shape pulls the transportation hole 5a of the medium 5 at two positions, i.e., the abutting positions J1 and J2. Accordingly, the medium 5 receives a force at the two positions, instead of one single position in the conventional printing apparatus, thereby preventing the force from concentrating.

When the pinwheel 1 rotates further, the pin 3 comes off from the transportation hole 5a of the medium 5. The medium 5 moves to a position between the printing head 8 and the platen 6 while the paper pan 7 guides the transportation of the medium 5, so that the printing head 8 prints-on the medium 5 and the medium 5 is discharged.

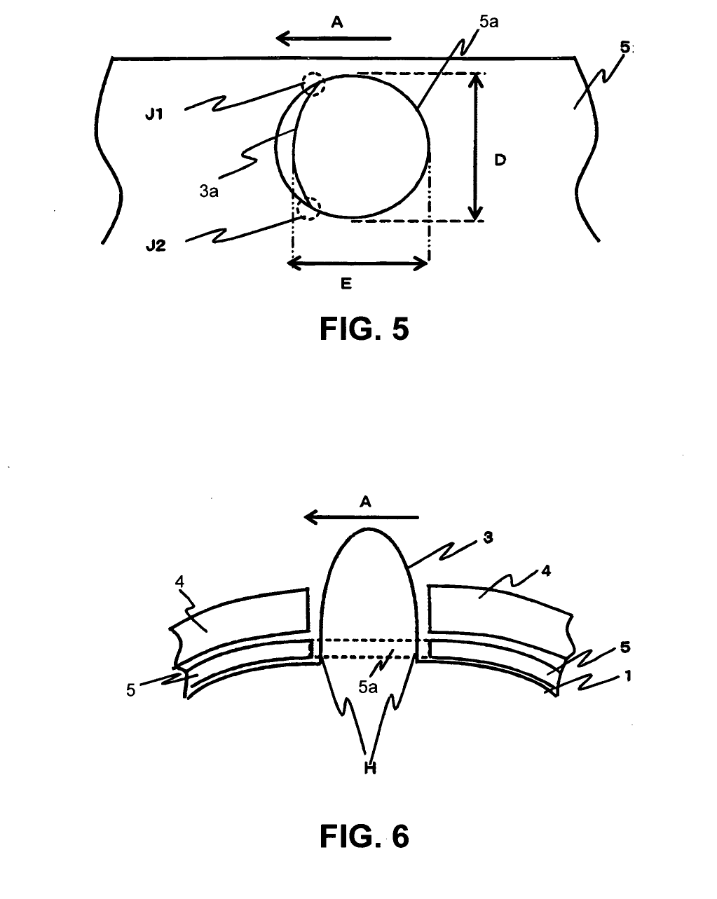

In the embodiment, the pin 3 has the substantially oval lateral sectional shape as shown in FIG. 1, and may have another shape. FIG. 5 is a schematic view showing a pin 3a of the pinwheel 1 and the transportation hole 5a of the medium 5 according to a modified example of the first embodiment of the present invention.

As shown in FIG. 5, the pin 3a has a semi-circular lateral sectional shape. More specifically, the pin 3a with a semi-circular shape has a lateral sectional shape having an oval portion only in the arrow direction A and a circular shape with a diameter E in the opposite direction. The pin 3a with the semi-circular shape abuts against the transportation hole 5a of the medium 5 at two positions, i.e., the abutting positions J1 and J2, thereby obtaining a similar effect.

As described above, in the embodiment, the pins 3 of the pinwheel 1 have the substantially oval sectional shape in the transportation direction. Accordingly, the pins 3 abut against the transportation holes 5a of the medium 5 at multiple positions. As a result, it is possible to disperse the force pulling the transportation holes 5a, thereby reducing deformation and noise. Further, it is possible to print an image with high accuracy in a vertical direction. Further, noise may not cause discomfort to a user, thereby providing the printing apparatus with high quality.

### Second Embodiment

A second embodiment of the present invention will be explained next.

In the second embodiment, the pinwheel 1 has a plurality of pins 9. Each of the pins 9 has a substantially oval lateral sectional shape similar to those in the first embodiment. Further, each of the pins 9 is inclined in a direction opposite to the transportation direction.

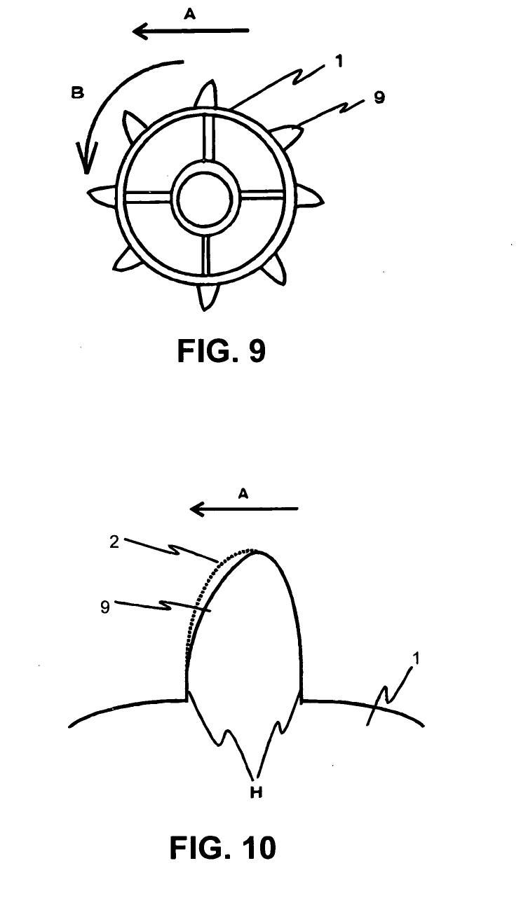

FIG. 9 is a schematic side view showing the pinwheel 1 according to the second embodiment of the present invention. FIG. 10 is a schematic view showing the pin 9 of the pinwheel 1 according to the second embodiment of the present invention. In FIG. 10, the conventional pin 2 is shown with a hidden line for comparison.

As shown in FIG. 10, as opposed to the conventional pin 2, the pin 9 with the inclination has a shape with a gentle inclination on a side toward the arrow direction A. Other components in the second embodiment are similar to those in the first embodiment, and explanations thereof are omitted.

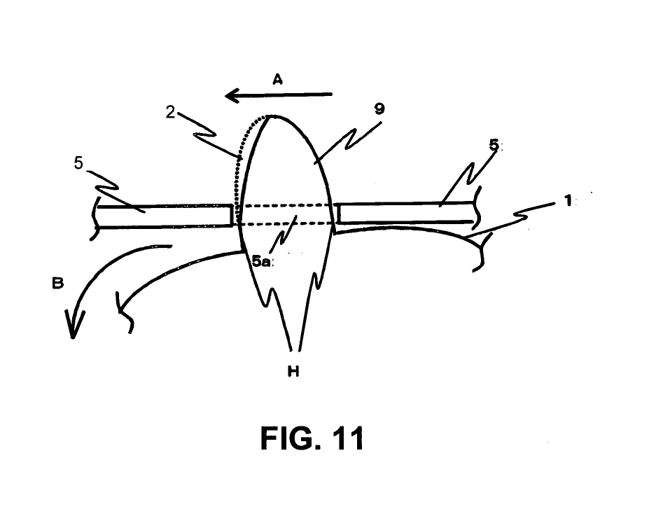

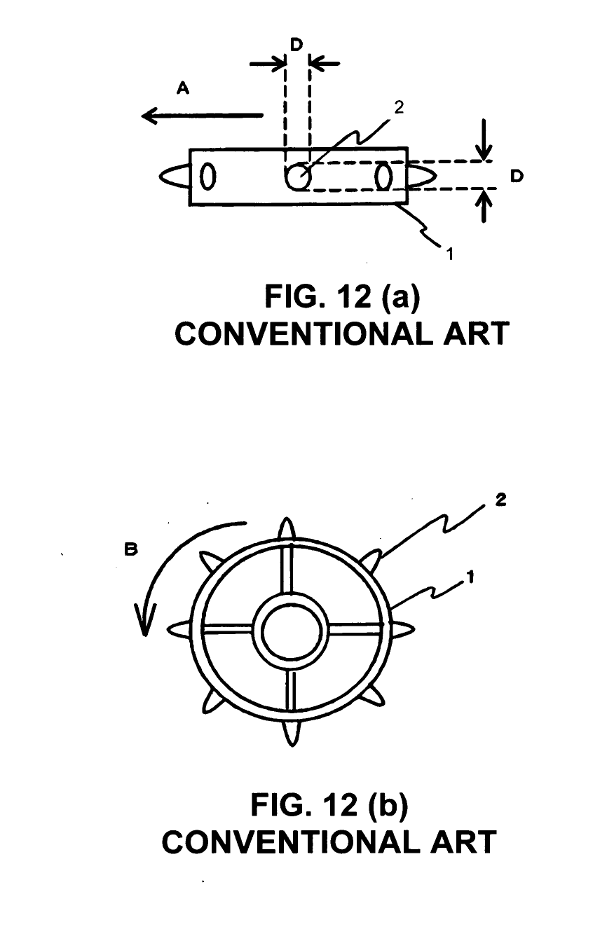

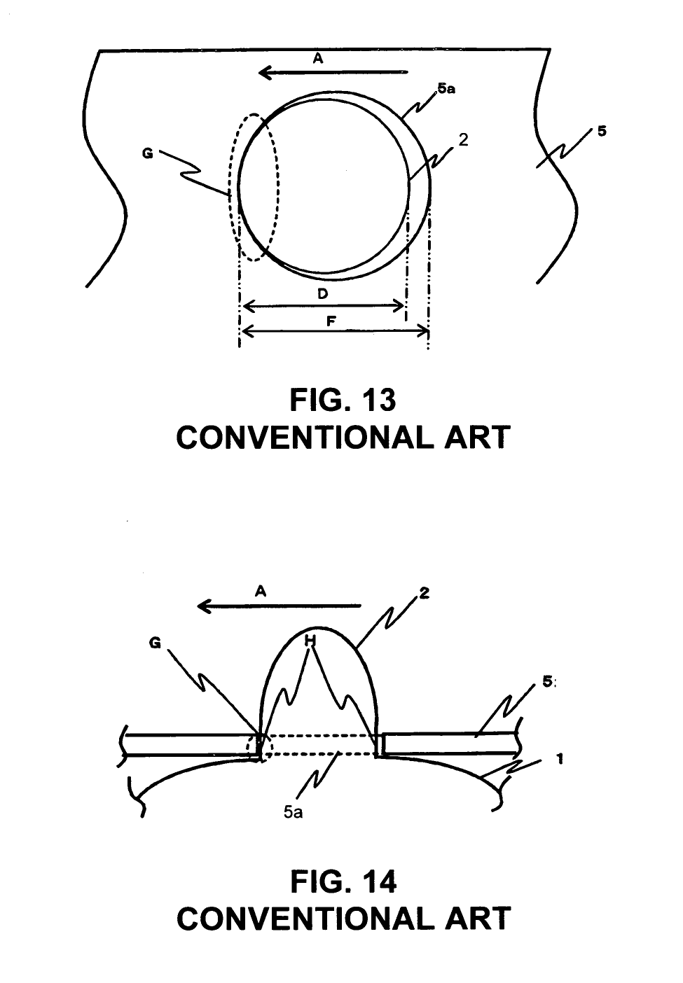

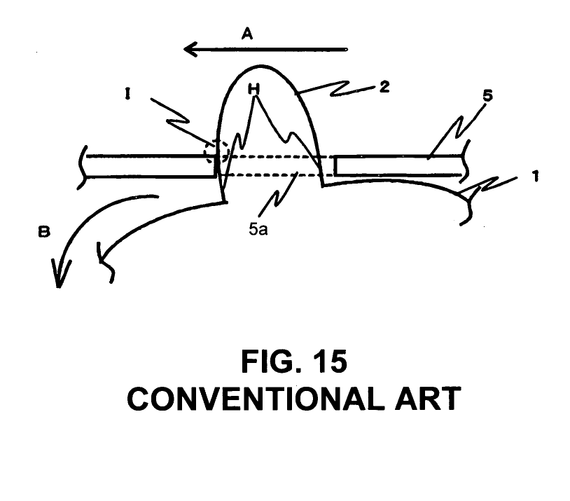

An operation of the printing apparatus 10 with the pinwheel 1 will be explained next with reference to FIG. 11. FIG. 11 is a schematic view showing the pinwheel 1 and the medium 5 in an operational state according to the second embodiment of the present invention.

In the operation, similar to the first embodiment, first, the pinwheel guide 4 is removed, and the transportation hole 5a of the medium 5 is set to the pin 9 with the inclination of the pinwheel 1. Then, the medium 5 is set with the pinwheel guide 4. When a printing operation is started or a transportation of a sheet is performed, the medium 5 is pressed with the pinwheel guide 4, and is transported in the arrow direction A along the circumferential surface of the pinwheel 1 while the pin 9 with the inclination engages the transportation hole 5a. At this time, the transportation hole 5a of the medium 5 abuts against the straight portion H of the pin 9 with the inclination at the base portion thereof.

As shown in FIG. 11, when the pinwheel 1 rotates further, the pinwheel 1 rotates in the arrow direction B and the pin 9 with the inclination is inclined. At this moment, since the pin 9 with the inclination has a cone shape with the gentle inclination on the side toward the arrow direction A, the pin 9 with the inclination is not caught with the transportation hole 5a of the medium 5, and smoothly comes off from the transportation hole 5a.

As described above, in the second embodiment, the pins 9 have the substantially oval lateral sectional shape, and are inclined in the direction opposite to the transportation direction. Accordingly, in addition to the effects of the first embodiment, the pins 9 with the inclination are not caught with the transportation holes 5a of the medium 5, and smoothly come off from the transportation hole 5a, thereby reducing deformation and noise.

Further, it is possible to print an image with high accuracy in a vertical direction. Further, noise may not cause discomfort to a user, thereby providing the printing apparatus with high quality.

As described above, the present invention is applicable to the printing apparatus having the pinwheel for transporting the printing medium such as a continuous sheet with transportation holes.

The disclosure of Japanese Patent Application No. 2007-140706, filed on May 28, 2007, is incorporated in the application by reference.

While the invention has been explained with reference to the specific embodiments of the invention, the explanation is illustrative and the invention is limited only by the appended claims.

What is claimed is:

1. A pinwheel comprising:
a plurality of pins arranged on a circumferential surface of the pinwheel with a specific interval for engaging transportation holes of a medium so that the medium is transported, each of said pins having a lateral section with a substantially oval shape.

2. The pinwheel according to claim 1, wherein each of said pins has the lateral section with the substantially oval shape having a curvature radius in a transportation direction of the medium larger than that of the transportation hole of the medium.

3. A pinwheel comprising:
a plurality of pins arranged on a circumferential surface of the pinwheel with a specific interval for engaging transportation holes of a medium so that the medium is transported, each of said pins having a lateral section with a gentle inclination in a transportation direction of the medium.

4. A printing apparatus comprising the pinwheel according to claim 1 and a printing unit for printing on the medium transported with the pinwheel.

5. A printing apparatus comprising the pinwheel according to claim 3 and a printing unit for printing on the medium transported with the pinwheel.
